(19) United States
(12) Patent Application Publication
(10) Pub. No.: US 2026/0215552 A1
(43) Pub. Date: Jul. 30, 2026

(54) WEARABLE DEVICE

(71) Applicant: Beijing Zitiao Network Technology Co., Ltd., Beijing (CN)

(72) Inventor: Junhui CHEN, Beijing (CN)

(21) Appl. No.: 19/351,060

(22) Filed: Oct. 6, 2025

(30) Foreign Application Priority Data
Jan. 27, 2025 (CN) 202510128579.8

(51) Int. Cl. A44C 5/00

(52) U.S. Cl. CPC A44C 5/0015

(57) ABSTRACT

This application relates to the technical field of wearable devices, and in particular, to a wearable device. The wearable device includes a housing, internally provided with an accommodation space and provided with a mounting space communicating with the accommodation space; and a speaker assembly, arranged in the mounting space, where both the mounting space and the accommodation space form a rear cavity of the speaker assembly.

### CROSS-REFERENCE TO RELATED APPLICATION(S)

This application claims priority to Chinese Application No. 202510128579.8 filed January 27, 2025, the disclosure of which is incorporated herein by reference in its entity.

### FIELD

This application relates to the technical field of wearable devices, and in particular, to a wearable device.

### BACKGROUND

With the development of technology, rings worn on fingers of users are continuously evolving into intelligent designs by incorporating components such as microphones, sensors, speakers, and batteries. These components are electrically connected through internally arranged flexible printed circuits (FPCs), thereby achieving interaction with the users, such as sending and receiving voice messages via mobile phones, and playing music and videos. Therefore, this kind of ring is increasingly popular among the users.

### SUMMARY

In order to solve the above-mentioned technical problems, this application provides a wearable device.

This application provides a wearable device, including:

a housing, internally provided with an accommodation space, and provided with a mounting space communicating with the accommodation space; and

a speaker assembly, arranged in the mounting space, where the mounting space and the accommodation space together form a rear cavity of the speaker assembly.

In some embodiments, the mounting space is constructed as a mounting through hole through which the accommodation space communicates with an external environment; or,

the mounting space is constructed as a mounting groove with an opening communicating with the accommodation space, and the housing is provided with a sound outlet hole communicating with the mounting groove.

In some embodiments, the wearable device is a ring or a wristband; and

the housing is constructed as an annular structure with a wearing hole, and one end of the housing opposite to the mounting space is provided with a hole communicating with the accommodation space.

In some embodiments, a waterproof and breathable membrane that covers the hole is arranged at a position, on an outer side of the accommodation space, of the housing.

In some embodiments, the housing is provided with a main housing and an annular housing which are integrally formed or separate parts, the main housing is provided with the mounting space, and the annular housing is arranged in the main housing; and

in an axis direction of the mounting through hole, the speaker assembly abuts against the annular housing or a preset gap is formed between the speaker assembly and the annular housing.

In some embodiments, a groove is hollowed out in an area of the annular housing corresponding to the mounting space, and the groove is configured to form the rear cavity.

In some embodiments, a cavity is hollowed out in an inner side of the housing, communicates with the accommodation space, and is configured to form the rear cavity of the speaker assembly.

In some embodiments, the housing is constructed as an annular structure with a wearing hole.

In some embodiments, the housing includes a main housing and an annular housing which are integrally formed or separate parts, the main housing is provided with the mounting space, and a central hole of the annular housing forms the wearing hole; and

the housing further includes an annular cover, and the annular cover is connected to the main housing and the annular housing to enclose and form the accommodation space.

In some embodiments, the housing includes an annular outer shell and an annular inner shell, the annular outer shell is provided with the mounting space, and a central hole of the annular inner shell forms the wearing hole; and

the housing also includes two annular covers, the two annular covers are respectively arranged on two sides of the annular inner shell in an axial direction, and the two annular covers are both connected between the annular inner shell and the annular outer shell.

In some embodiments, the wearable device is a ring, and the housing is provided with a wearing hole.

In some embodiments, the wearable device is a wristband, and the housing is provided with an arc-shaped wearing surface.

In some embodiments, the housing is provided with a wearing hole for the wrist to pass through, and the arc-shaped wearing surface forms a hole wall surface of the wearing hole; or,

the wristband also includes a strap, the strap is connected to the housing, and the strap is configured to bind the housing to the wrist.

### BRIEF DESCRIPTION OF THE DRAWINGS

The accompanying drawings herein are incorporated into the specification to form a part of the specification, illustrate embodiments conforming to this application, and are used to explain the principle of this application together with the specification.

In order to more clearly illustrate the technical solutions in the embodiments of this application or in the prior art, the accompanying drawings used for describing the embodiments or the prior art will be briefly described below. Apparently, those of ordinary skill in the art may still derive other accompanying drawings from these accompanying drawings without creative efforts.

FIG. 1 is a schematic structural diagram of a ring in the prior art;

FIG. 2 is a schematic structural diagram of a wearable device according to some embodiments of this application;

FIG. 3 is a schematic structural diagram of the wearable device in FIG. 2 from another perspective;

FIG. 4 is a schematic sectional view of the wearable device in FIG. 2 from one perspective;

FIG. 5 is a schematic sectional view of the wearable device in FIG. 2 from another perspective;

FIG. 6 is a schematic structural diagram of a wearable device according to some embodiments of this application; and

FIG. 7 is a schematic sectional view of the wearable device in FIG. 6 from one perspective.

In the figures, 1'-speaker; 2'-outer shell; 3'-inner shell; 10'-rear cavity;

1-speaker assembly;

2-housing; 21-main housing; 22-annular housing; 23-annular cover; 201-cavity; 202-hole;

3-electrical assembly; and

10-accommodation space.

### DETAILED DESCRIPTION OF EMBODIMENTS

For a clearer understanding of the above-mentioned objectives, features, and advantages of this application, the solutions of this application will be further described below. It should be noted that embodiments in this application and features in the embodiments may be mutually combined without conflicts.

Many specific details are elaborated in the following description to facilitate a full understanding of this application, but this application may also be implemented in methods different from those described herein. Apparently, the embodiments in the specification are only a part rather all of the embodiments of this application.

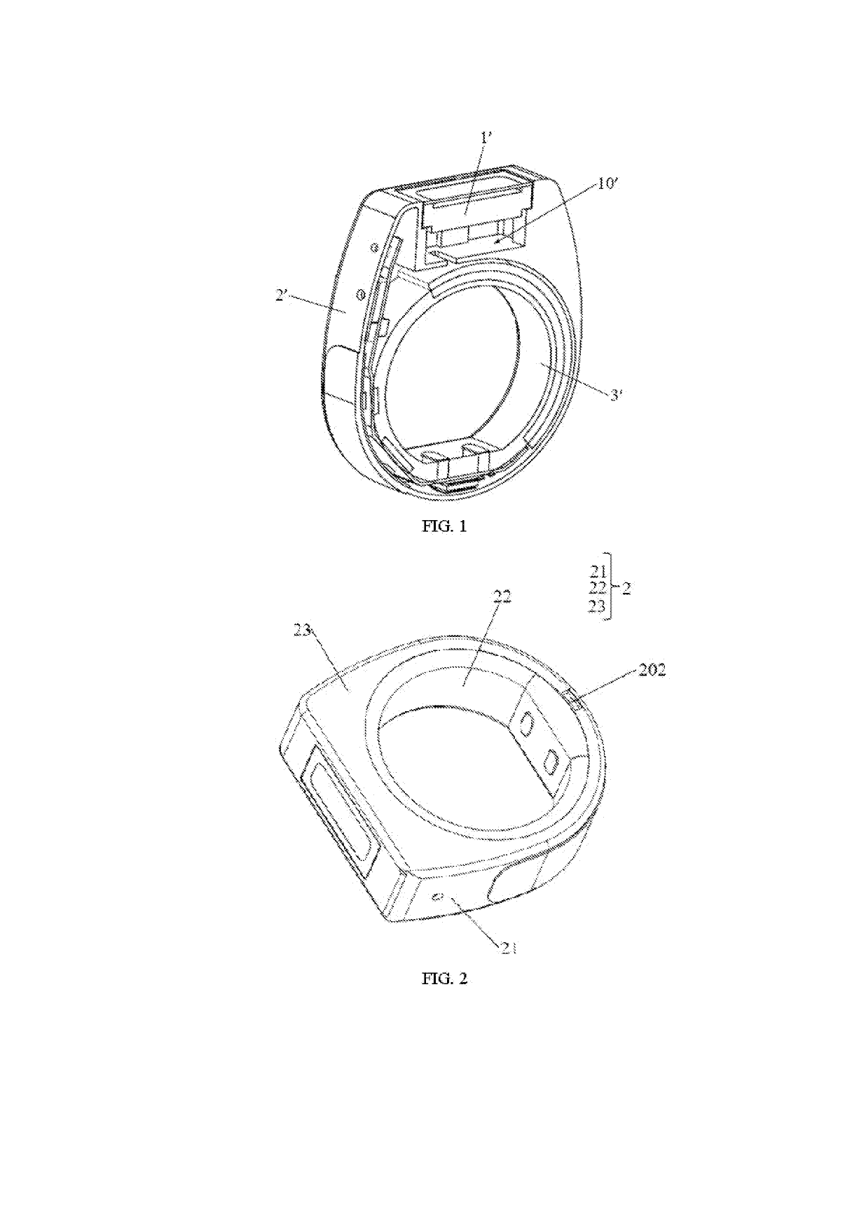

Currently, referring to FIG. 1, a housing of each of some rings is typically composed of an outer shell 2' and an inner shell 3'. An annular space is formed between the outer shell 2' and the inner shell 3' to install components such as a circuit board. The annular space is usually filled with glue to seal the components. When the ring is worn, the inner shell 3' makes contact with the finger. For a ring with a speaker, due to a limited space, the speaker 1' is typically arranged on the outer shell 2'. A cavity is separately formed in the outer shell 2' corresponding to the speaker 1' for mounting of the speaker 1', with part of the cavity forming a rear cavity 10' of the speaker 1' to meet operational requirements of the speaker 1'. The cavity is isolated from the annular space, resulting in a protruding local area of the ring where the speaker 1' is arranged, which causes the poor aesthetic appeal of the ring and affects the user experience.

Compared with the prior art, the technical solutions provided in the embodiments of this application have the following advantages:

according to the wearable device, the mounting space communicating with the accommodation space is arranged on the housing, both the mounting space and the accommodation space form the rear cavity of the speaker assembly, and therefore there is no need to arrange a chamber in the housing that is isolated from the accommodation space to form the rear cavity of the speaker assembly, thereby reducing an overall size of a position of the housing where the speaker assembly is arranged, solving the problem of a protruding local area on the housing where the speaker assembly is arranged, improving the aesthetic appeal of the wearable device, and enhancing user experience.

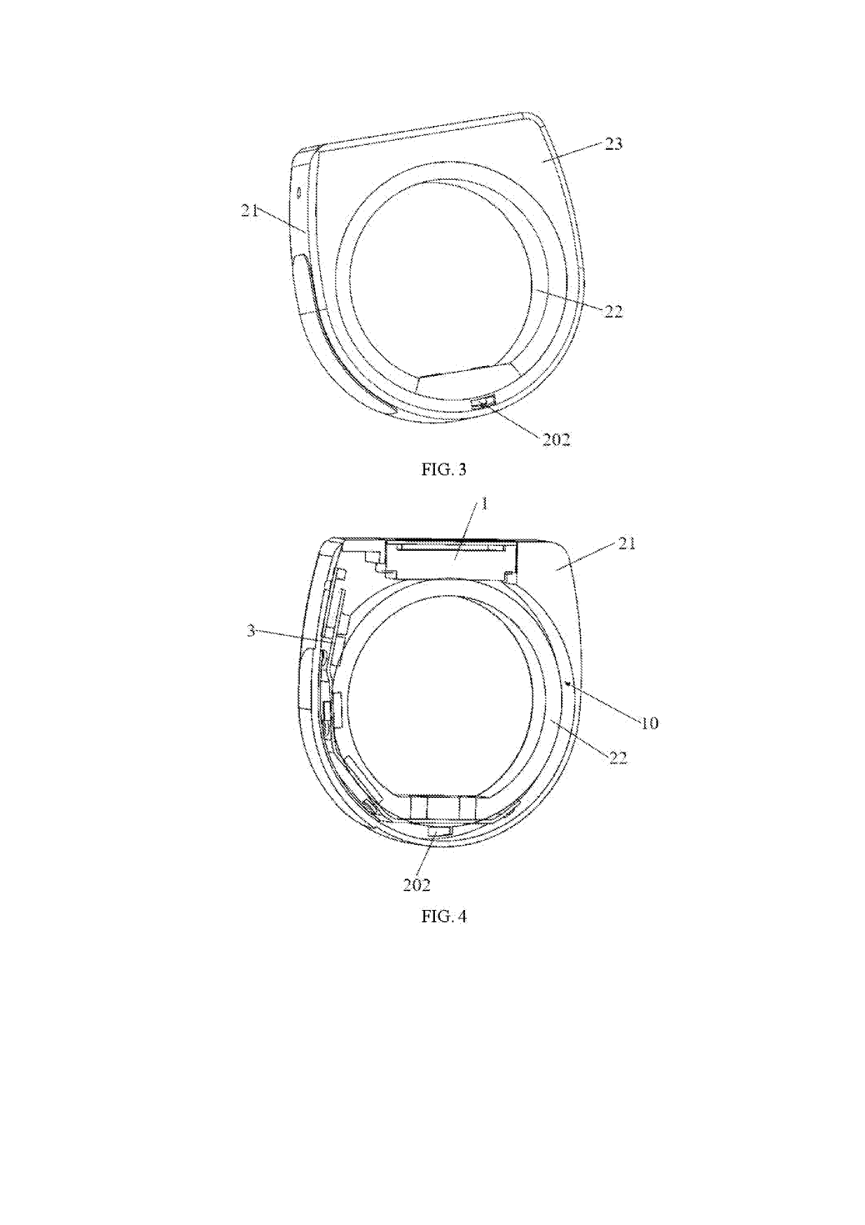

As shown in FIG. 2 to FIG. 7, an embodiment of this application provides a wearable device, including a housing 2 and a speaker assembly 1. The housing 2 is internally provided with an accommodation space 10, and is provided with a mounting space communicating with the accommodation space 10. The speaker assembly 1 is arranged in the mounting space, and both the mounting space and the accommodation space 10 form a rear cavity of the speaker assembly 1.

It should be understood that the mounting space communicating with the accommodation space 10 is arranged on the housing 2, the housing 2 is provided with a cavity 201 communicating with the accommodation space 10, both the mounting space and the accommodation space 10 form the rear cavity of the speaker assembly 1, and therefore there is no need to arrange a chamber in the housing 2 that is isolated from the accommodation space 10 to form the rear cavity of the speaker assembly 1, and the mounting space and the accommodation space 10 form the rear cavity of the speaker assembly 1, thereby reducing an overall size of a position of the housing 2 where the speaker assembly 1 is arranged, solving the problem of a protruding local area on the housing 2 where the speaker assembly 1 is arranged, improving the aesthetic appeal of the wearable device, and enhancing user experience.

It should be noted that the mounting space and the accommodation space 10 are in communication, with no structure having a separation function between the mounting space and the accommodation space 10, and may be regarded as an integrated space. In contrast, in the prior art, the mounting space and the accommodation space are two separate spaces that are isolated from each other. Even if there is any communication, it is merely a channel for wiring, and in essence, the mounting space and the accommodation space remain two independent spaces. Additionally, the above-mentioned accommodation space 10 may be an annular space, an arc-shaped space, or alternatively, a square space, a circular space, etc.

Further, the above-mentioned wearable device also includes an electrical assembly 3, which is arranged within the above-mentioned accommodation space 10. The electrical assembly 3 includes a plurality of components. Specific types of the components may be set according to functions that the ring is intended to achieve. For example, the plurality of components include a microphone, a battery, a mainboard, a Bluetooth module, etc. In this case, the wearable device may establish a communication with a mobile phone through the Bluetooth module, thereby allowing a user to make calls, send and receive voice messages, play music, and achieve other functions through the wearable device.

In some embodiments, referring to FIG. 2 to FIG. 5, the wearable device is a ring or a wristband. The housing 2 is constructed as an annular structure with a wearing hole. One end of the housing 2 opposite to the mounting space is provided with a hole 202 communicating with the accommodation space.

It should be understood that the design of the hole 202 allows the speaker assembly 1 to have the open rear cavity, and accordingly, the wearable device can be audible when positioned close to the user ear. When the wearable device is farther from the user ear, the sound emitted by the speaker assembly 1 diminishes, thereby allowing the user to privately listen by bringing the wearable device close to the ear, while other people may not hear or clearly hear the sound emitted by the speaker assembly 1 due to the mutual cancellation of a front cavity and the rear cavity of the speaker assembly 1.

It should be noted that a radial end of the wearing hole of the housing 2 may be provided with the above-mentioned mounting space, the other end is provided with the above-mentioned hole 202, that is, the mounting space and the hole 202 are opposite, and therefore, when the wearable device is the ring, the hole 202 may be located on the hand back side, and the mounting space is located on the palm side. When the wearable device is the wristband, the mounting space is located on the inner side of the wrist, and the hole 202 is located on the outer side of the wrist.

Taking the wearable device being the ring as an example, the wearable device can be worn on the user finger, with the end where the speaker assembly 1 is installed located on the palm side and the end with the hole 202 located on the hand back side. Therefore, when listening to the sound, the palm can be placed against the user face, with the speaker assembly 1 on the inner side of the hand and the hole 202 on the outer side of the hand. The palm acts as a partition to isolate the front cavity and the rear cavity of the speaker assembly 1, thereby allowing the user to make calls or listen to voice messages in a private mode.

Certainly, when the wearable device is the wristband, the above-mentioned wearable device may be worn on the user wrist, with the end where the speaker assembly 1 is installed located on the inner side of the wrist and the end with the hole 202 located on the outer side of the wrist. Therefore, when listening to the sound, the wrist can be brought close to the user face, and the wrist acts as a partition to isolate the front cavity and the rear cavity of the speaker assembly 1, thereby allowing the user to make calls or listen to voice messages in the private mode.

Optionally, a waterproof and breathable membrane (not shown in the figures) that covers the hole 202 is arranged at a position, on an outer side of the accommodation space 10, of the above-mentioned housing 2. The waterproof and breathable membrane is preferably made of an expanded polytetrafluoroethylene (ePTFE) material, and has billions of micropores, which can not only ensure reliable air permeability but also balance pressure, thereby providing reliable waterproof protection for the wearable device. Certainly, a material of the waterproof and breathable membrane may also be selected from a thermoplastic polyurethane (TPU) film, a polyurethane (PU) film, etc.

It should be understood that the arrangement of the waterproof and breathable membrane can provide waterproof and dustproof effects, prevent external dust or foreign objects from entering the cavity 201, as well as prevent water or sweat from the user body from entering the cavity.

Further, the above-mentioned waterproof and breathable membrane may be designed to be detachable, such as being fixed to a second housing through glue bonding, thereby allowing the user to remove and replace the waterproof and breathable membrane after a period of use.

Optionally, in some other embodiments, there may be no hole formed in the housing.

In some embodiments, referring to FIG. 4, the above-mentioned mounting space is constructed as a mounting through hole through which the accommodation space 10 communicates with an external environment. In this case, the above-mentioned speaker assembly 1 is installed in the mounting through hole, and the end of the mounting through hole for communicating with the external environment may be used as a sound outlet hole for the speaker assembly 1.

Optionally, in some other embodiments, the above-mentioned mounting space may also be constructed as a mounting groove with an opening communicating with the accommodation space, and a first housing is provided with a sound outlet hole communicating with the mounting groove. In this case, a position of the sound outlet hole may be set according to actual needs, meaning that the sound outlet hole may face in any direction.

In some embodiments, referring to FIG. 4, the above-mentioned accommodation space 10 includes a first space and a second space that are in communication, the mounting space communicates with the first space, and in this case, both the mounting space and the first space form the rear cavity of the speaker assembly 1.

The wearable device includes the electrical assembly 3, which is arranged within the second space. Placing the electrical assembly 3 within the second space facilitates the sealing of the electrical assembly 3 through glue filling and avoids affecting the speaker assembly 1.

It should be noted that an area of the second space that communicates with the first space and does not contain the electrical assembly 3 may not be filled with glue, and in this case, this part of the second space may also serve as the rear cavity of the speaker assembly 1, thereby increasing a volume of the rear cavity. Certainly, the first space and the second space above may also be set to be non-communicating. When the first space does not communicate with the second space, glue filling and sealing of the electrical assembly 3 can avoid affecting the first space.

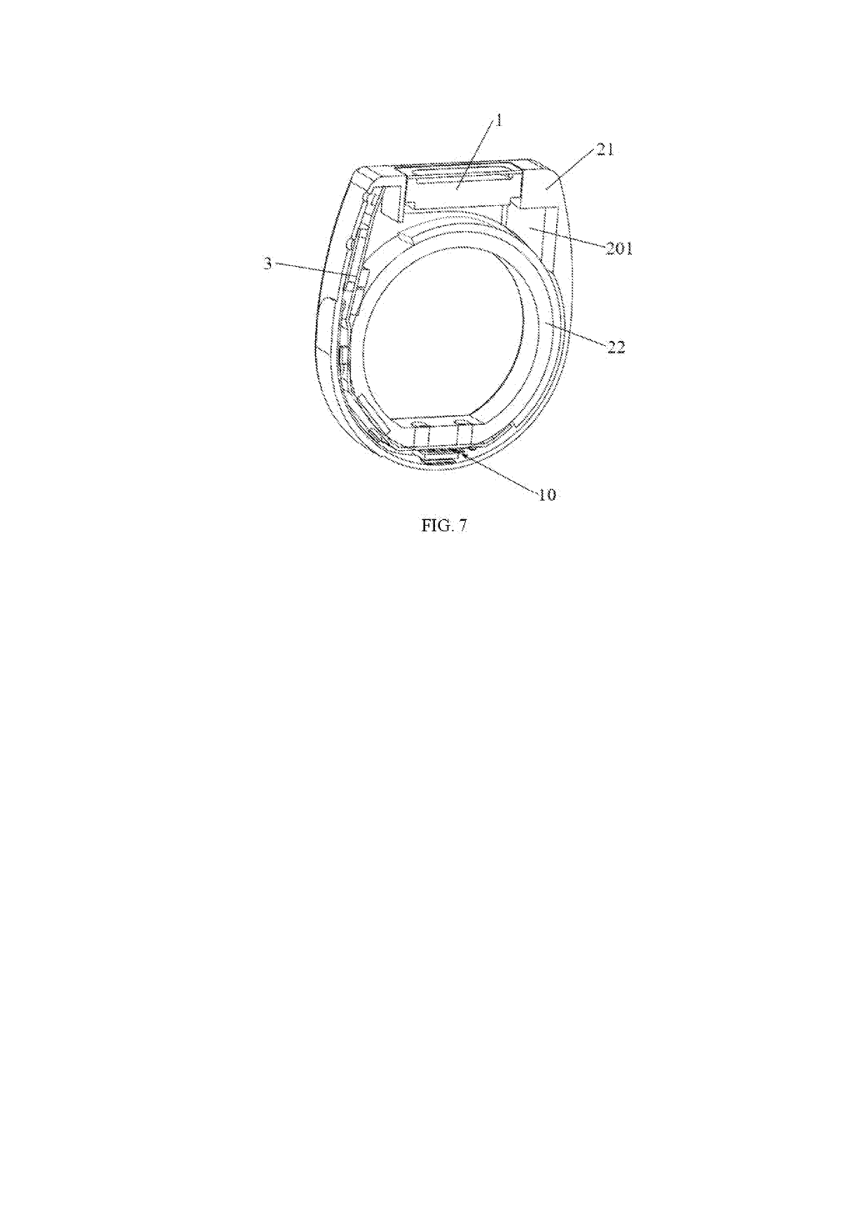

In some embodiments, referring to FIG. 5 to FIG. 7, the cavity 201 is hollowed out in an inner side of the housing 2, communicates with the accommodation space, and is configured to construct the rear cavity of the speaker assembly 1. Exemplarily, the cavity 201 may be at least one arc-shaped groove that is hollowed out, as shown in FIG. 5.The cavity 201 may also be a notch that is hollowed out, as shown in FIG. 7.

Specifically, the above-mentioned housing includes a main housing 21 and an annular housing 22. The annular housing 22 is arranged in the main housing 21. The above-mentioned accommodation space 10 is enclosed between the annular housing 22 and the main housing 21. The main housing 21 is provided with the above-mentioned mounting space, and in this case, the cavity 201 is hollowed out in the inner side of the main housing 21.

In this case, when the mounting space is constructed as the mounting groove with the opening communicating with the accommodation space 10, the sound outlet hole may be formed in the main housing 21, or the annular housing 22, or a junction between the main housing 21 and the annular housing 22. Additionally, the above-mentioned hole 202 may also be set to communicate with the cavity 201, and in this case, the hole 202 is formed in the main housing 21.

In some embodiments, the housing 2 is provided with the main housing 21 and the annular housing 22 which are integrally formed or separate parts. The annular housing 22 is arranged in the main housing 21, and the main housing 21 is provided with the mounting space. The speaker assembly 1 abuts against the annular housing 22, or a preset gap is formed between the speaker assembly 1 and the annular housing 22.

It should be understood that by arranging the speaker assembly 1 to abut against the annular housing 22, the speaker assembly 1 can be supported through the annular housing 22, thereby improving stability of the speaker assembly 1; and meanwhile, an overall thickness of the housing 2 provided with the speaker assembly 1 can be greatly reduced (in this case, the thickness of the housing 2 refers to a thickness of the housing 2 in a radial direction of the annular housing 22), that is, a distance between the main housing 21 and the annular housing 22 in the area of the speaker assembly 1 is reduced, thereby solving the problem of the protruding area of the housing where the speaker assembly 1 is arranged.

The preset gap is formed between the speaker assembly 1 and the annular housing 22, thereby further utilizing a space between the speaker assembly 1 and the annular housing 22. Certainly, compared with the prior art, the thickness of the position of the housing 2 where the speaker assembly 1 is arranged is also reduced.

Optionally, a groove may also be hollowed out in the area of the annular housing 22 corresponding to the mounting space, and the groove is configured to form the rear cavity. By arranging the groove in the annular housing, a space of the annular housing 22 in a thickness direction can be used to increase the volume of the rear cavity of the speaker assembly 1, thereby improving the sound quality of the speaker assembly.

Exemplarily, in a specific implementation, referring to FIG. 4 and FIG. 5, the above-mentioned speaker assembly 1 abuts against the annular housing 22. In this case, the above-mentioned wearable device may be selected as the ring or the wristband, and in this case, a central hole of the annular housing 22 forms the wearing hole of the wearable device. The main housing 21 and the annular housing 22 are separately arranged. The main housing 21 is provided with a bottom plate and a surrounding plate encircling the bottom plate. The bottom plate is provided with a first communication hole, and the above-mentioned surrounding plate is provided with a mounting space.

The housing 2 also includes an annular cover 23, the other end of the annular housing 22 in an axial direction is connected to the annular cover 23, and the annular cover 23 is connected to the main housing 21 and the annular housing 22 to encircle the accommodation space 10. Both the main housing 21 and the annular cover 23 are provided with the above-mentioned cavities 201, and in this case, the cavities 201 are in the form of the arc-shaped grooves. Additionally, the above-mentioned hole 202 is formed in the above-mentioned main housing 21 and/or the annular cover 23.

In this case, the above-mentioned accommodation space 10 may be divided into a first space and a second space that are in communication, the mounting space communicates with the first space, and in this case, both the mounting space and the first space form the rear cavity of the speaker assembly 1.

Alternatively, the above-mentioned main housing may also be set as an annular housing. Meanwhile, the housing also includes annular covers. The two annular covers are respectively arranged on two sides of an annular inner shell in the axial direction, and the two annular covers are both connected between the annular inner shell and an annular outer shell. In this case, the above-mentioned hole 202 is formed in the above-mentioned main housing 21 and/or the annular cover 23.

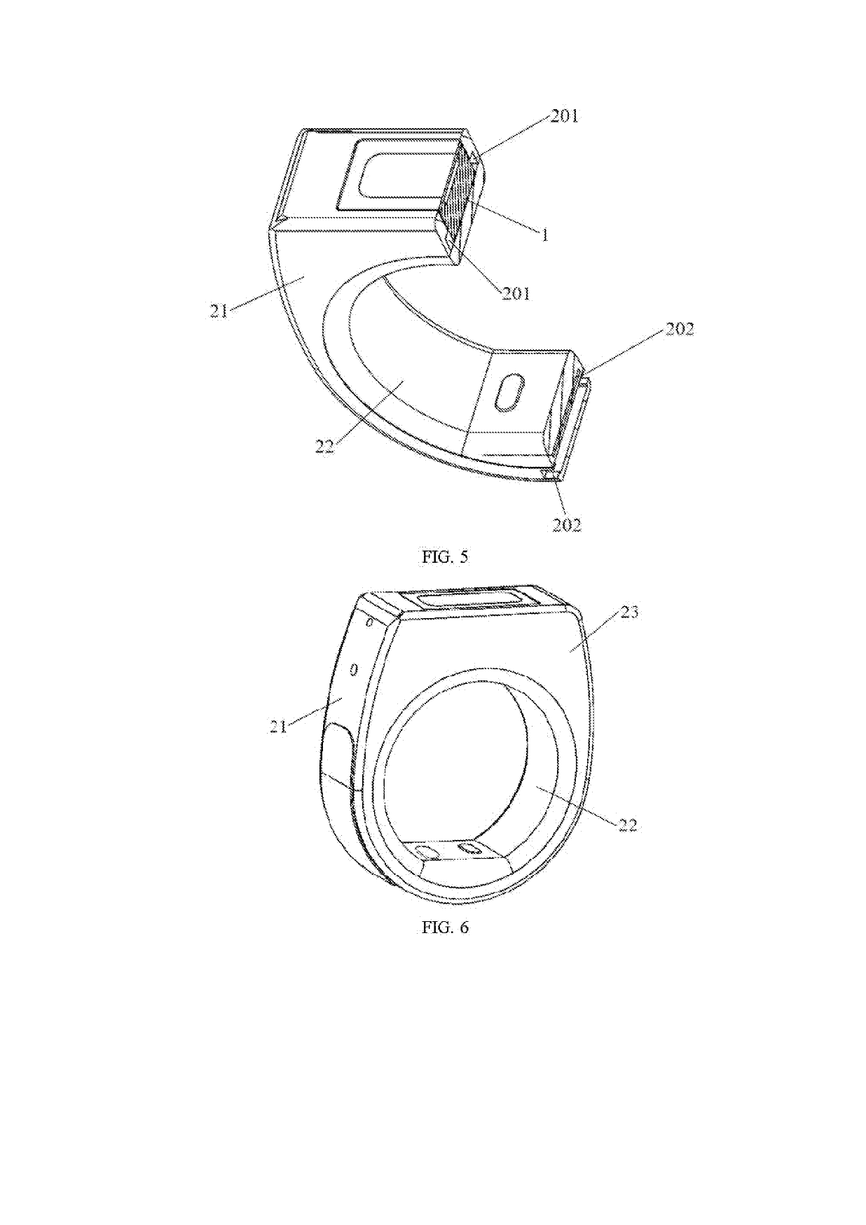

Exemplarily, in another specific implementation, referring to FIG. 6 and FIG. 7, a preset gap is formed between the above-mentioned speaker assembly 1 and the annular housing 22. In this case, the above-mentioned wearable device may be selected as the ring or the wristband, and in this case, a central hole of the annular housing 22 forms the wearing hole of the wearable device. The main housing 21 and the annular housing 22 are separately arranged. The main housing 21 is provided with a bottom plate and a surrounding plate encircling the bottom plate. The bottom plate is provided with a first communication hole, and the above-mentioned surrounding plate is provided with a mounting space.

The housing 2 also includes an annular cover 23, the other end of the annular housing 22 in the axial direction is connected to the annular cover 23, and the annular cover 23 is connected to the main housing 21 and the annular housing 22 to encircle the accommodation space 10. The above-mentioned main housing 21 is provided with the above-mentioned cavity 201, and the cavity 201 is in the form of a groove.

Additionally, in this case, the above-mentioned accommodation space 10 may be divided into a first space and a second space that are in communication, the mounting space communicates with the first space, and in this case, both the mounting space and the first space form the rear cavity of the speaker assembly 1.

Optionally, in another embodiment, the above-mentioned housing may further include an upper shell and a lower shell that can be in snap fit. The upper shell is provided with the above-mentioned mounting hole, and the speaker assembly abuts against the lower shell or a preset gap is formed between the speaker assembly and the annular housing. In this case, the first housing and/or the second housing may be provided with a cavity, and in this case, the cavity may be a groove or channel.

In some embodiments, the above-mentioned housing 2 is constructed as an annular structure with a wearing hole. In this case, the wearable device may be a ring, a finger ring, or a wristband.

Exemplarily, in a specific implementation, referring to FIG. 2 to FIG. 5, the housing 2 is provided with the main housing 21 and the annular housing 22 which are integrally formed or separately arranged. The annular housing 22 is arranged in the main housing 21, the main housing 21 is provided with the mounting space, and the central hole of the annular housing 22 forms the above-mentioned wearing hole.

Taking the main housing 21 and the annular housing 22 which are separate parts as an example, the main housing 21 includes a bottom plate and a surrounding plate encircling the bottom plate, the bottom plate is provided with a first communication hole, and one end of the annular housing 22 in the axial direction is connected to the bottom plate. The housing 2 is also provided with the annular cover 23, and the annular cover 23 is connected to the main housing 21 and the annular housing 22 to encircle the accommodation space 10. That is, in this case, the housing 2 is composed of three parts: the main housing 21, the annular housing 22, and the annular cover 23, such that the central hole of the annular housing 22 forms the wearing hole.

In this case, when the mounting space is constructed as the mounting groove with the opening communicating with the accommodation space 10, the sound outlet hole may be formed in the main housing 21, or the annular housing 22, or a junction between the main housing 21 and the annular housing 22, or the annular cover 23.

It should be noted that in this case, one end of the annular housing 22 in the axial direction may extend into the first communication hole and be flush with an outer side surface of the bottom plate, the other end of the annular housing 22 in the axial direction may extend into a central hole of the annular cover 23 and be flush with an outer side surface of the annular cover 23, and in this case, the central hole of the annular housing 22 is the wearing hole. Alternatively, the two ends of the annular housing in the axial direction may be arranged to not extend into or partially extend into the first communicating hole and the central hole of the cover respectively, and in this case, the central hole of the annular housing, the first communicating hole, and the central hole of the annular cover jointly form the wearing hole.

Accordingly, when assembling the wearable device, the main housing 21 and the annular housing 22 may be assembled first, then the electrical assembly 3 is arranged in the accommodation space 10, and subsequently, the annular cover 23 is assembled to seal the accommodation space 10. Moreover, an area where the electrical assembly 3 is arranged may be filled with glue for sealing. Certainly, when the main housing 21 and the annular housing 22 are integrally formed, an assembly process of the main housing 21 and the annular housing 22 may be omitted.

Exemplarily, the above-mentioned annular housing 22 may be set to be circular or approximately circular, which is conducive to fitting the user finger and improving wearing comfort. Alternatively, the annular housing 22 may have an arc-shaped wearing surface, such that when the wearable device is worn, the wearable device may fit the finger through the arc-shaped wearing surface, thereby improving the wearing comfort. In this case, the annular housing 22 may be in other shapes, such as a square ring shape.

Exemplarily, in another specific implementation, the above-mentioned housing includes an annular outer shell and an annular inner shell, the annular outer shell is provided with a mounting space, and a central hole of the annular inner shell forms the wearing hole. In this case, the housing may also include two annular covers. The two annular covers are respectively arranged on two sides of the annular inner shell in the axial direction, and the two annular covers are both connected between the annular inner shell and the annular outer shell. That is, in this case, the housing is composed of the annular inner shell, the annular outer shell, and the two annular covers. An annular accommodation space is formed between the annular inner shell and the annular outer shell, while the two annular covers respectively seal the two sides of the accommodation space in the axial direction of the annular inner shell, thereby forming an annular structure with the wearing hole.

In this case, when the mounting space is constructed as the mounting groove with the opening communicating with the accommodation space 10, the sound outlet hole may be formed in the annular outer shell, or the annular inner shell, or a junction between the annular outer shell and the annular inner shell, or the annular covers.

In some embodiments, referring to FIG. 2 to FIG. 5, the above-mentioned wearable device may be a ring, and in this case, the housing 2 is provided with a wearing hole. Accordingly, when the ring is worn, the ring fits over the user finger through the wearing hole.

Exemplarily, the above-mentioned housing 2 is provided with the main housing 21 and the annular housing 22 which are integrally formed or separately arranged. The annular housing 22 is arranged in the main housing 21, the main housing 21 is provided with the mounting space, and the central hole of the annular housing 22 forms the above-mentioned wearing hole.

Taking the main housing 21 and the annular housing 22 which are separate parts as an example, the main housing 21 includes a bottom plate and a surrounding plate encircling the bottom plate, the bottom plate is provided with a first communication hole, and one end of the annular housing 22 in the axial direction is connected to the bottom plate. The housing 2 is also provided with the annular cover 23, and the annular cover 23 is connected to the main housing 21 and the annular housing 22 to encircle the accommodation space 10. That is, in this case, the housing 2 is composed of three parts: the main housing 21, the annular housing 22, and the annular cover 23, such that the central hole of the annular housing 22 forms the wearing hole.

It should be noted that in this case, one end of the annular housing 22 in the axial direction may extend into the first communication hole and be flush with an outer side surface of the bottom plate, the other end of the annular housing 22 in the axial direction may extend into a central hole of the annular cover 23 and be flush with an outer side surface of the annular cover 23, and in this case, the central hole of the annular housing 22 is the wearing hole. Alternatively, the two ends of the annular housing in the axial direction may be arranged to not extend into or partially extend into the first communicating hole and the central hole of the cover respectively, and in this case, the central hole of the annular housing, the first communicating hole, and the central hole of the annular cover jointly form the wearing hole.

Accordingly, when assembling the wearable device, the main housing 21 and the annular housing 22 may be assembled first, then the electrical assembly 3 is arranged in the accommodation space 10, and subsequently, the annular cover 23 is assembled to seal the accommodation space 10. Moreover, an area where the electrical assembly 3 is arranged may be filled with glue for sealing. Certainly, when the main housing 21 and the annular housing 22 are integrally formed, an assembly process of the main housing 21 and the annular housing 22 may be omitted.

Exemplarily, the above-mentioned annular housing 22 may be set to be circular or approximately circular, which is conducive to fitting the user finger and improving wearing comfort. Alternatively, the annular housing 22 may have an arc-shaped wearing surface, such that when the wearable device is worn, the wearable device may fit the finger through the arc-shaped wearing surface, thereby improving the wearing comfort. In this case, the annular housing 22 may be in other shapes, such as a square ring shape.

Optionally, in some other embodiments, the above-mentioned wearable device may also be a wristband, and in this case, the housing is provided with an arc-shaped wearing surface. Accordingly, when the wearable device fits over the user wrist, the arc-shaped wearing surface can be fitted with the user wrist, thereby improving wearing comfort. Certainly, the above-mentioned housing may also have a wearing plane, and when the wearable device is worn, the wearing plane is fitted with the user body surface.

It should be noted that even if the housing is provided with the arc-shaped wearing surface, the arc-shaped wearing surface cannot be fitted with the wrist of every user but rather provides relative fitness, thereby relatively improving the wearing comfort of the wristband.

It should be noted that when the above-mentioned wearable device is the wristband, in one case, the above-mentioned housing is provided with the main housing and the annular housing which are integrally formed or separately provided. The annular housing is arranged in the main housing, the main housing is provided with the mounting space, and the central hole of the annular housing forms the above-mentioned wearing hole.

Taking the main housing and the annular housing which are separately formed as an example, the main housing includes a bottom plate and a surrounding plate encircling the bottom plate, the bottom plate is provided with a first communication hole, and one end of the annular housing in the axial direction is connected to the bottom plate. The housing is also provided with the annular cover, and the annular cover is connected to the main housing and the annular housing to encircle the accommodation space. That is, in this case, the housing is composed of three parts: the main housing, the annular housing, and the annular cover, such that the central hole of the annular housing forms the wearing hole.

In another case, the wristband may also include a strap connected to the housing. The strap can bind the housing to the wrist, that is, the wristband is worn through the strap. For example, the housing includes the upper shell and the lower shell that can be in snap fit. The upper shell is provided with the above-mentioned mounting hole, and the lower shell is provided with the above-mentioned arc-shaped wearing surface.

It should be noted that herein, relational terms such as "first" and "second" are used only to distinguish one entity or operation from another and do not necessarily require or imply any actual relationship or order between these entities or operations. Moreover, the terms "include", "including", or any of their variants are intended to cover a non-exclusive inclusion, such that a process, a method, an article, or a device that includes a list of elements not only includes those elements but also includes other elements that are not expressly listed, or further includes elements inherent to such process, method, article, or device. In the absence of more restrictions, an element defined by "including a/an …" does not exclude another identical element in a process, a method, an article, or a device that includes the element.

The above-mentioned description illustrates merely specific implementations of this application, such that those skilled in the art can understand or implement this application. Various modifications to these embodiments are apparent to those skilled in the art, and the general principle defined herein may be implemented in other embodiments without departing from the spirit or scope of this application. Therefore, this application will not be limited to the embodiments shown herein but needs to conform to a widest scope consistent to the principles and novel characteristics disclosed herein.

We claim:

1. A wearable device, comprising:
a housing, internally provided with an accommodation space, and provided with a mounting space communicating with the accommodation space; and
a speaker assembly, arranged in the mounting space, the mounting space and the accommodation space together forming a rear cavity of the speaker assembly.

2. The wearable device according to claim 1, wherein the mounting space is constructed as a mounting through hole through which the accommodation space communicates with an external environment; or,
the mounting space is constructed as a mounting groove with an opening communicating with the accommodation space, and the housing is provided with a sound outlet hole communicating with the mounting groove.

3. The wearable device according to claim 1, wherein the wearable device is a ring or a wristband; and
the housing is constructed as an annular structure with a wearing hole, and one end of the housing opposite to the mounting space is provided with a hole communicating with the accommodation space.

4. The wearable device according to claim 3, wherein a waterproof and breathable membrane that covers the hole is arranged at a position, on an outer side of the accommodation space, of the housing.

5. The wearable device according to claim 1, wherein the housing is provided with a main housing and an annular housing which are integrally formed or separate parts, the main housing is provided with the mounting space, and the annular housing is arranged in the main housing; and
the speaker assembly abuts against the annular housing or a preset gap is formed between the speaker assembly and the annular housing.

6. The wearable device according to claim 5, wherein a groove is hollowed out in an area of the annular housing corresponding to the mounting space, and the groove is configured to form the rear cavity.

7. The wearable device according to claim 1, wherein a cavity is hollowed out in an inner side of the housing, communicates with the accommodation space, and is configured to form the rear cavity of the speaker assembly.

8. The wearable device according to claim 1, wherein the housing is constructed as an annular structure with a wearing hole.

9. The wearable device according to claim 8, wherein the housing comprises a main housing and an annular housing which are integrally formed or separate parts, the main housing is provided with the mounting space, and a central hole of the annular housing forms the wearing hole; and
the housing further comprises an annular cover, and the annular cover is connected to the main housing and the annular housing to enclose and form the accommodation space.

10. The wearable device according to claim 8, wherein the housing comprises an annular outer shell and an annular inner shell, the annular outer shell is provided with the mounting space, and a central hole of the annular inner shell forms the wearing hole; and
the housing further comprises two annular covers, the two annular covers are respectively arranged on two sides of the annular inner shell in an axial direction, and the two annular covers are both connected between the annular inner shell and the annular outer shell.

11. The wearable device according to claim 1, wherein the wearable device is a ring, and the housing is provided with a wearing hole.

12. The wearable device according to claim 1, wherein the wearable device is a wristband, and the housing is provided with an arc-shaped wearing surface.

13. The wearable device according to claim 12, wherein the housing is provided with a wearing hole for the wrist to pass through, and the arc-shaped wearing surface forms a hole wall surface of the wearing hole; or
the wristband also comprises a strap, the strap is connected to the housing, and the strap is configured to bind the housing to the wrist.

14. A wristband, comprising:
a housing, internally provided with an accommodation space, and provided with a mounting space communicating with the accommodation space an arc-shaped wearing surface; and
a speaker assembly, arranged in the mounting space, the mounting space and the accommodation space together forming a rear cavity of the speaker assembly.

15. The wearable device according to claim 14, wherein the mounting space is constructed as a mounting through hole through which the accommodation space communicates with an external environment; or,
the mounting space is constructed as a mounting groove with an opening communicating with the accommodation space, and the housing is provided with a sound outlet hole communicating with the mounting groove.

16. The wristband according to claim 14, wherein the wearable device is a ring or a wristband; and
the housing is constructed as an annular structure with a wearing hole, and one end of the housing opposite to the mounting space is provided with a hole communicating with the accommodation space.

17. The wristband according to claim 16, wherein a waterproof and breathable membrane that covers the hole is arranged at a position, on an outer side of the accommodation space, of the housing.

18. The wristband according to claim 14, wherein the housing is provided with a main housing and an annular housing which are integrally formed or separate parts, the main housing is provided with the mounting space, and the annular housing is arranged in the main housing; and
the speaker assembly abuts against the annular housing or a preset gap is formed between the speaker assembly and the annular housing.

19. The wristband according to claim 18, wherein a groove is hollowed out in an area of the annular housing corresponding to the mounting space, and the groove is configured to form the rear cavity.

20. The wristband according to claim 14, wherein a cavity is hollowed out in an inner side of the housing, communicates with the accommodation space, and is configured to form the rear cavity of the speaker assembly.
